(19) United States
(12) Patent Application Publication
(10) Pub. No.: US 2006/0110955 A1
(43) Pub. Date: May 25, 2006

(54) Electrical apparauts

(75) Inventor: Mike Blossfeld, South Lyon, MI (US)

Correspondence Address: TAROLLI, SUNDHEIM, COVEL, & TUMMINO L.L.P., 1111 LEADER BLDG, 526 SUPERIOR AVENUE, CLEVELAND, OH, 44114-1400, US

(73) Assignee: TRW Automotive U.S. LLC

(21) Appl. No.: 10/995,719

(22) Filed: Nov. 22, 2004

(51) Int. Cl. H01R 12/00

(52) U.S. Cl. 439/82

(57) ABSTRACT

An electrical apparatus includes a printed circuit board having an opening with a conductive lining. A conductive socket has leg portions which are biased into contact with the conductive lining to provide a predetermined force resisting removal of the socket from the opening. A conductive device, such as a terminal, is received in the socket opening. The conductive device acts on the leg portions of the socket to increase the predetermined force which resists removal of the socket from the opening in the printed circuit board.

### BACKGROUND OF THE INVENTION

The present invention relates to a new and improved electrical apparatus having a socket which is received in an opening in a printed circuit board.

A known socket has legs which are received in an opening in a printed circuit board. The socket extends through the printed circuit board and the legs are soldered to a conductor on the printed circuit board. A shoulder of the socket engages an upper side of the printed circuit board. Projections from the legs engage the lower side of the circuit board to position the socket relative to the printed circuit board. A socket having this construction is disclosed in U.S. Pat. No. 2,814,024.

### SUMMARY OF THE INVENTION

The present invention provides an electrical apparatus having a conductive socket which is at least partially located in an opening in a printed circuit board. The opening in the printed circuit board has a conductive lining. Upon insertion of the socket into the opening in the printed circuit board, leg portions of the socket are pressed against the conductive lining to provide a predetermined force resisting removal of the socket from the opening in the printed circuit board. Upon insertion of a conductive device into the socket, the predetermined force with which the leg portions of the socket resist removal of the socket from the opening in the printed circuit board is increased.

### BRIEF DESCRIPTION OF THE DRAWINGS

The foregoing and other features of the invention will become more apparent upon a consideration of the following description taken in connection with the accompanying drawings wherein:

FIG. 1 is an upper plan view of a socket housing which holds a plurality of sockets which form part of an electrical circuit;

FIG. 2 is a pictorial illustration of one of the sockets held by the socket housing of FIG. 1;

FIG. 3 is a pictorial illustration further depicting the construction of the socket of FIG. 2;

FIG. 4 is a schematic illustration depicting the manner in which the socket housing of FIG. 1 and the socket of FIGS. 2 and 3 are positioned relative to a printed circuit board; and

FIG. 5 is a schematic illustration depicting circuitry for controlling operation of a motor to raise and lower a window of a vehicle.

### DESCRIPTION OF PREFERRED EMBODIMENT

An apparatus representative of the present invention is illustrated in the drawings. The apparatus includes a socket housing 46 (FIG. 1) which is made of a rigid electrically non-conductive material. The socket housing 46 may be formed of a polymeric material. Although the socket housing 46 has been illustrated in FIG. 1 as having a rectangular configuration, it is contemplated that the socket housing may have a different configuration if desired. For example, the socket housing 46 may have a circular configuration.

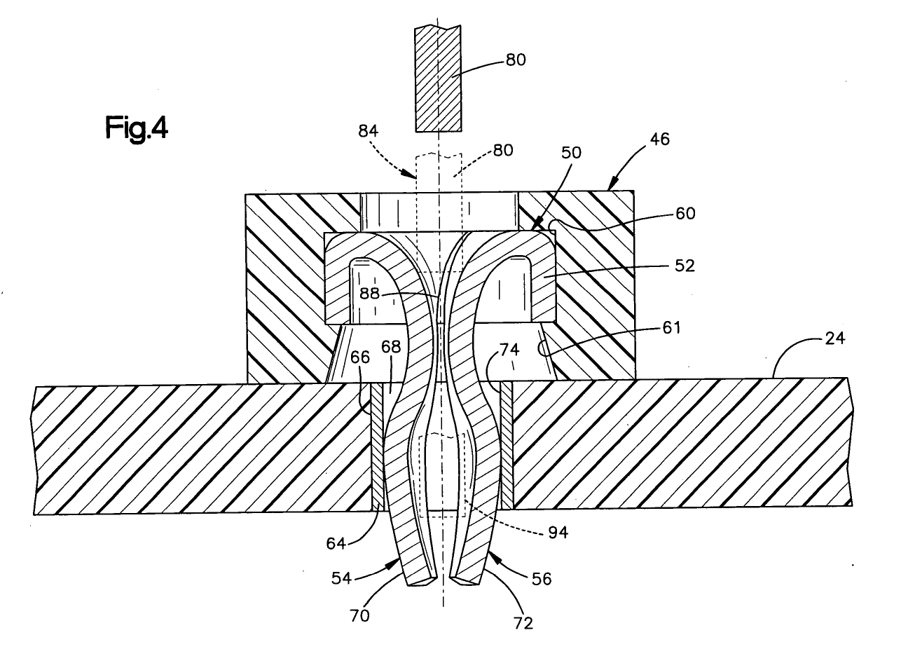

A plurality of sockets 50 (FIGS. 1-3) are mounted on the socket housing 46. The plurality of sockets 50 can be simultaneously connected with a printed circuit board 24 (FIG. 4) by moving the socket housing 46 toward an upper side (as viewed in the drawings) of the printed circuit board.

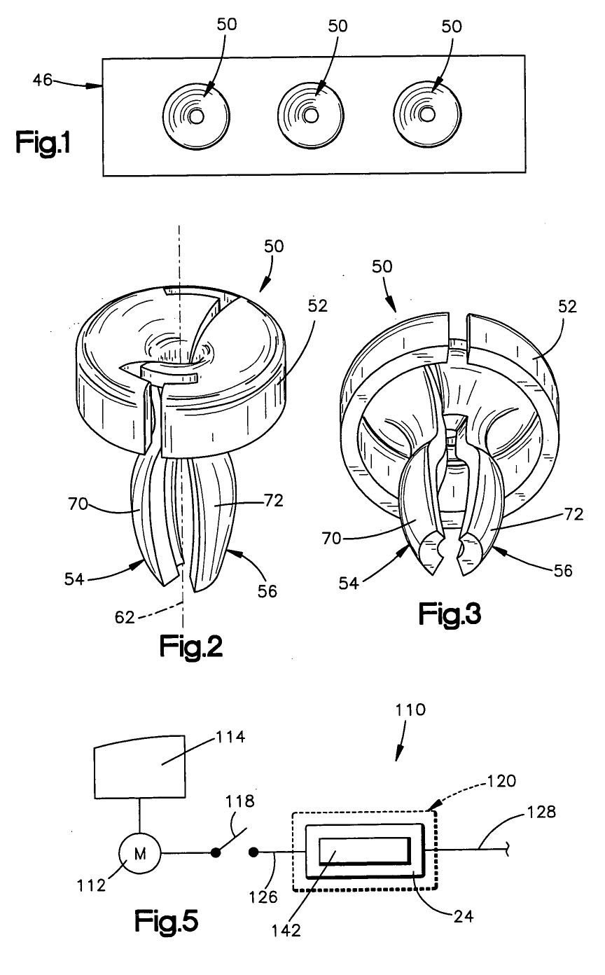

The sockets 50 all have the same construction. Each socket 50 includes a cylinderical head end portion 52 (FIGS. 2 and 3) and a plurality of resiliently deflectable leg portions 54 and 56 which extend from the head end portion 52. The socket 50 is formed of a single piece of a resilient electrically conductive material. The socket 50 preferably is one-piece and not separate pieces secured together. The socket 50 is formed of a spring metal, such as C521000 or C702500. Of course, the socket 50 may be formed of other materials if desired.

The head end portion 52 (FIGS. 2 and 3) and leg portions 54 and 56 are one-piece and integrally formed from one piece of electrically conductive material. The head end portion 52 of the socket 50 is resiliently deflectable to grip the inside of a cylinderial recess 60 (FIG. 4) formed in the socket housing 46.

When the socket 50 (FIG. 4) is to be mounted on the socket housing 46, the head end portion 52 of the socket is axially aligned with the cylindrical recess 60 in the socket housing. The head end portion 52 of the socket 50 is then moved upward (as viewed in FIG. 4) into engagement with a frustro-conical cam surface 61. As the socket 50 continues to move upward toward the recess 60, the cam surface 61 is effective to resiliently compress the head end portion 52 of the socket 50 in a radial direction. The head end portion 52 of the socket 50 resiliently expands radially outward as the head end portion moves into the recess 60. This results in the socket 50 being mounted on the socket housing 46 in the manner illustrated in FIG. 4.

The leg portions 54 and 56 of the socket 50 are resiliently deflectable. The leg portions 54 and 56 grip a cylinderical conductive lining 64 (FIG. 4). The conductive lining 64 is disposed on the inside of a cylinderical opening 66 extending through the printed circuit board 24. The conductive lining 64 has a cylindrical central opening 68 which is coaxial with the opening 66 in the printed circuit board 24. The conductive lining 64 is fixedly secured to the printed circuit board 24.

When the socket 50 is in the unrestrained condition illustrated in FIGS. 2 and 3, the maximum lateral dimension between outer side surfaces 70 and 72 of the leg portions 54 and 56, as measured perpendicular to this axis 62, is greater than the diameter of the cylindrical inner side surface 74 of the conductive lining 64 (FIG. 4). Therefore, when the leg portions 54 and 56 of the socket 50 are inserted into the opening 66 in the printed circuit board 24, engagement of the leg portions with the inner side surface 74 of the conductive lining 64 resiliently deflects the leg portions 54 and 56 toward each other. This results in the socket 50 having a predetermined initial resistance to removal of the leg portions 54 and 56 from the opening 66 in the printed circuit board 24.

In one specific instance, the initial predetermined resistance to removal (pull out) of one socket 50 (FIG. 4) from the printed circuit board 24 was approximately two pounds. Thus, in order to disengage the one socket 50 from the opening 68 after the leg portions 54 and 56 of the socket have been inserted into the opening in the manner illustrated in FIG. 4, a pull out force of two pounds or more would have to be applied to the socket 50 to pull the socket upwards (as viewed in FIG. 4). Of course, the initial predetermined pull out force required to disengage the socket 50 from the opening 68 may be more or less than the previously mentioned predetermined force of two pounds.

After the socket 50 has been inserted into the opening 68 in the lining 64 for the opening 66 in printed circuit board 24, in the manner illustrated in FIG. 4, a cylinderical conductive device 80 is connected with the socket 50. The conductive device 80 may be a terminal extending from an electronic device. Alternatively, the conductive device 80 may be a conductor connected with another electrical component. When the conductive device 80 is a terminal of an electronic device, the electronic device may be any of a variety of devices including a light emitting diode, capacitor, relay, or other known device.

When the conductive device 80 is inserted into the socket 50, the conductive device is moved downward relative to the socket to an initial contact position indicated in dashed lines at 84 in FIG. 4. The cylinderical conductive device 80 has a diameter which is greater than the diameter of an upper portion of a passage 88 through the socket 50. Further downward movement of the cylinderical conductive device 80 resiliently deflects the leg positions 54 and 56 of the socket radially outward at a location which is above (as viewed in FIG. 4) a location where the leg positions engage the cylindrical conductive lining 64. As this occurs, the circular cross sectional area of a portion of the central passage 88 in the socket is enlarged.

As the conductive device 80 continues to be forced into the socket 50, the conductive device moves downward (as viewed in FIG. 4) in the central passage 88 from the initial contact position 84 to a final position indicated in dashed lines at 94 in FIG. 4. As the conductive device 80 moves downward in the central passage 88, a portion of the passage is radially expanded. Since the leg portion 54 and 56 of the socket 50 are disposed in the cylindrical opening 68 in the conductive lining 64, the maximum external diameter of the leg portions can not be increased. Therefore, as the conductive device 80 is moved into the central passage in the socket 50, the leg portions 54 and 56 are resiliently deflected in a radially outward direction at a location between where the conductive device 80 initially engages the socket 50 and where the leg portions engage the conductive lining 64.

As this occurs, the force applied by the outer side surfaces 70 and 72 of the leg portions 54 and 56 against the inner side surface 74 of the conductive lining 64 increases. Therefore, there is a resulting increase in the resistance of the socket to being removed from the opening 66 in the printed circuit board 24.

It is contemplated that the resistance of the socket 50 to being pulled out of the opening 66 on the printed circuit board 24 may be increased to any desired magnitude by movement of the conductive device 80 into the central passage 88 in the socket to the final position indicated in dashed lines at 94 in FIG. 4. However, in one specific instance, the force applied by the leg portions 54 and 56 against the inner side surface 74 of the conductive lining 64 resulted in a force of four pounds or more being required to pull the socket 50 out of the opening 66. Thus, in the specific example described herein, the predetermined force required to pull the socket 50 out of the opening 66 doubled from two pounds to four pounds. It is contemplated that the socket 50 will be constructed so that the force required to pull the socket out of the opening 66 will increase by at least thirty percent upon insertion of the conductive device 80 into the socket passage 88 to the final position indicated in dashed lines at 94 in FIG. 4.

It is contemplated that the socket 50 will be utilized in many different types of circuits. Depending upon the type of circuit in which the socket 50 is to be used, either a greater or lesser number of sockets 50 may be provided in the socket housing 46. For example, the socket housing 46 may be constructed so as to receive only a single socket 50. Alternatively, the housing 46 may be constructed so as to receive more than the three sockets 50 illustrated in FIG. 1.

It is believed that the housing 46 will be particularly advantageous when a relatively large number of sockets 50 are to be used in a circuit. When this is the situation, the housing 46 will be constructed with a relatively large number of recesses 60. The sockets 50 will all be simultaneously connected with a printed circuit board 24 by pressing the housing 46 against the printed circuit board with the leg portions 54 and 56 of the sockets 50 extending into a plurality of openings 66 in the printed circuit board 24.

The circuit housing 46 and sockets 50 (FIG. 1) may advantageously be used in control circuitry 110 (FIG. 5) connected with an electric motor 112 which is operable to raise and lower a window 114 of a vehicle. The control circuitry 110 includes a manually operable switch 118 and a control unit 120. The control unit 120 includes the printed circuit board 24 which is connected with the switch 118 and a source of power by conductors 126 and 128. Other conductors may connected with the printed circuit board 24. An electronic device 142 is mounted on the printed circuit board 24 and is connected with one or more of the conductors.

From the above description of the invention, those skilled in the art will perceive improvements, changes and modifications. Such improvements, changes and modifications within the skill of the art are intended to be covered by the appended claims.

Having described the invention, the following is claimed:

1. An electrical apparatus comprising:
a printed circuit board having an opening with a conductive lining;
a conductive socket is at least partially located in said opening and has leg portions biased into contact with said conductive lining providing a predetermined force resisting removal of said leg portions from said opening, said force being provided due to said leg portions having a lateral dimension greater than a lateral dimension of the lining prior to insertion of said leg portions into said opening, said socket having a socket opening therein; and
a conductive device received in said socket opening and being retained in said socket opening due to said conductive device having a lateral dimension greater than said socket opening prior to said conductive device being inserted into said socket opening;
said conductive device acting on said leg portions and increasing said predetermined force.

2. An electrical apparatus as defined in claim 1 wherein said conductive device increases said predetermined force by at least 30%.

3. An electrical apparatus as defined in claim 1 wherein said socket is positioned in a base prior to being located in said opening in said printed circuit board.

4. An electrical apparatus as set forth in claim 1 further including a socket housing, said socket having a head end portion which is disposed in said socket housing and is connected with said leg portions of said socket.

5. An electrical apparatus as set forth in claim 1 further including a socket housing with a plurality of sockets having head end portions disposed in openings in said socket housing and leg portions extending from said socket housing, said leg portions of said plurality of sockets being simultaneously movable into a plurality of openings in said printed circuit board by moving said socket housing toward said printed circuit board.

6. An electrical apparatus as set forth in claim 1 wherein said printed circuit board is connected with a motor which is operable to move a window relative to a vehicle.

7. An electrical apparatus as set forth in claim 1 wherein a first portion of said leg portions of said socket are engaged by said conductive device and a second portion of said leg portions of said socket engage said conductive lining, said first and second portions of said leg portions of said socket being spaced apart lengthwise along said leg portions of said socket.
